(19) United States
(12) Patent Application Publication
(10) Pub. No.: US 2017/0171344 A1
(43) Pub. Date: Jun. 15, 2017

(54) SCHEDULING METHOD AND SERVER FOR CONTENT DELIVERY NETWORK SERVICE NODE

(71) Applicants: LE HOLDINGS (BEIJING) CO., LTD., Beijing (CN); LECLOUD COMPUTING CO., LTD., Beijing (CN)

(72) Inventor: Hongfu LI, Beijing (CN)

(21) Appl. No.: 15/246,134

(22) Filed: Aug. 24, 2016

Related U.S. Application Data
(63) Continuation of application No. PCT/CN2016/088861, filed on Jul. 6, 2016.

(30) Foreign Application Priority Data
Dec. 15, 2015 (CN) 201510931364.6

(51) Int. Cl. H04L 29/08; H04L 12/44

(52) U.S. Cl. CPC H04L 67/2842; H04L 12/44; H04L 67/1021

(57) ABSTRACT

The present disclosure provides a scheduling method and server for a CDN service node. The method include determining distance metric values between the nodes, generating a minimum spanning tree based on all distance metric values between all nodes, receiving an access request of a user, and determining a position and a requested content of the user, determining a caching node closest to the user and caching the content using the minimum spanning tree, and selecting the caching node as a service node responding to the access request. A scheduling server is further provided correspondingly.

### CROSS REFERENCE TO RELATED APPLICATIONS

This application is a continuation of International Application No. PCT/CN2016/088861, filed on Jul. 6, 2016, which is based upon and claims priority to Chinese Patent Application No. 201510931364.6, filed on Dec. 15, 2015, the entire contents of both of which are incorporated herein by reference.

### TECHNICAL FIELD

The present disclosure relates to the technical field of internet, in particular to a scheduling method and server for a content delivery network (CDN) service node.

### BACKGROUND

The full name of CDN is Content Delivery Network. A CDN aims to issue the content of a website to the “edge” of a network closest to a user by adding a layer of new network structure into the existing Internet. As a result, the user can acquire the required content nearby, congestion of the Internet network is solved, and a response speed of the user to access to the website is improved.

### SUMMARY

The present disclosure provides a scheduling method, server and non-transitory computer-readable storage medium for a CDN service node.

According to one aspect of the present disclosure, a scheduling method for a CDN service node is provided. The method may include: generating a minimum spanning tree based on all distance metric values between all nodes, receiving an access request of a user, and determining a position and a requested content of the user, determining a caching node closest to the user and caching the content using the minimum spanning tree, and selecting the caching node as a service node responding to the access request.

According to another aspect of the present disclosure, a scheduling server for a CDN service node is provided. The scheduling server may include: at least one processor, and a memory communicably connected with the at least one processor for storing instructions executable by the at least one processor, wherein execution of the instructions by the at least one processor causes the at least one processor to: generate a minimum spanning tree based on all distance metric values between all nodes, receive an access request of a user, and determine a position and a requested content of the user, determine a caching node closest to the user and caching the content using the minimum spanning tree, and select the caching node as a service node responding to the access request.

According to an additional aspect of the present disclosure, a non-transitory computer-readable storage medium storing executable instructions is provided. The executable instructions, when executed by a processor, may cause the processor to: determine distance metric values between the nodes, generate a minimum spanning tree based on all distance metric values between all nodes, receive an access request of a user, and determining a position and a requested content of the user, determine a caching node closest to the user and caching the content using the minimum spanning tree, and select the caching node as a service node responding to the access request.

It should be understood that both the foregoing general description and the following detailed description are exemplary and explanatory only and are not restrictive of the disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

In order to more clearly indicate a technical solution of the embodiments of the present disclosure, drawings required in the description of the embodiments are briefly introduced, and it is obvious that the drawings described below are some embodiments of the present disclosure, and those ordinary skilled in the art can obtain other drawings according to those drawings without creative labor.

FIG. 1 is a flow drawing of an embodiment of a scheduling method for a CDN service node of the present disclosure;

FIG. 2 is a flow drawing of another embodiment of a scheduling method for a CDN service node of the present disclosure;

FIG. 3 is a flow drawing of a further embodiment of a scheduling method for a CDN service node of the present disclosure;

FIG. 4 is a schematic drawing of an embodiment of a scheduling server for a CDN service node of the present disclosure;

FIG. 5 is a schematic drawing of an embodiment of a caching node determining module in the present disclosure;

FIG. 6 is a flow drawing of another embodiment of a caching node determining module in the present disclosure;

FIG. 7 is a structural drawing of a system realizing the scheduling method and server for a CDN service node of the present disclosure; and

FIG. 8 is a schematic structural drawing of an embodiment of an electronic device of the present disclosure.

### DETAILED DESCRIPTION

In order to make the purpose, technical solutions, and advantages of the embodiments of the disclosure more clearly, technical solutions of the embodiments of the present disclosure will be described clearly and completely in conjunction with the figures. Obviously, the described embodiments are merely part of the embodiments of the present disclosure, but not all embodiments. Based on the embodiments of the present disclosure, other embodiments obtained by the ordinary skill in the art without inventive efforts are within the scope of the present disclosure.

The terminology used in the present disclosure is for the purpose of describing exemplary embodiments only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may include used herein to describe various information, the information should not be limited by these terms. These terms are only used to distinguish one category of information from another. For example, without departing from the scope of the present disclosure, first information may include termed as second information; and similarly, second information may also be termed as first information. As used herein, the term “if” may include understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may include combined in any suitable manner.

It should be noted that, embodiments of the present application and the technical features involved therein may be combined with each other in case they are not conflict with each other.

The present disclosure is applicable to various general-purpose and specific-purpose computer system environments or configurations, such as a personal computer, a server computer, a handheld device or portable device, a tablet device, a multi-processor system, a microprocessor-based system, a set-top box, a programmable consumer electronic device, a network PC, a mini-computer, a mainframe computer, a distributed computing environment including any of the above-listed systems or devices.

The present disclosure can be described in a general context where a computer executes computer-executable instructions, such as program modules. Typically, program modules include routines, programs, objects, components, data structures, etc. which perform certain tasks or implement certain abstract data types. The present disclosure can also be implemented in a distributed computing environment, where tasks are performed by a remote processing device connected through a communication network. In a distributed computing environment, program modules may be stored in storage mediums including memory device of the local and remote computer.

Finally, it should also be noted that, wordings like first and second are merely for separating one entity or operation from the other, but not intended to require or imply a relation or sequence among these entities or operations. Further, terms like “comprise”, “include” and the like are to be construed as including not only the elements described, but also those elements not specifically described, or further including elements which are essential to such process, method, article or device. Unless the context clearly requires, throughout the description and the claims, elements defined by recitation with “comprising . . . ” should not be construed as exclusive from the process, method, article or device including said elements of other equivalent elements.

The CDN technology is divided into a dynamic speeding technology and a static speeding technology. The static speeding technology is widely used at present, that is, CDN nodes are deployed at the edge of the network. When the user requests certain services, by scheduling, namely, using a global sever load balance (GSLB) strategy, the CDN system orients the user to an edge node closest to the user, and the node is in charge of processing the request of the user. If the content of requested by the user is cached on the node and effective, the cached content is sent to the user. Otherwise, the node proxies the user to initiate a back-to-source request to other nodes or a source station server and search for a back-to-source path by scheduling. The content requested by the user is obtained based on the back-to-source path and is then forwarded to the user, thereby finishing the processing on the request of this time.

The inventor finds in the process of implementing the present disclosure that the CDN network has many nodes, but sometimes there is only one uploaded data source, particularly in live broadcast. A general method at present is to determine a shortest path for returning to the source according to certain methods if the node at the edge does not have the content requested by the user, and finally, the source station server providing a data source is found for the user. However, a case that the requested content is already cached in the nodes of the whole CDN network is not considered in the prior art. Actually, other users may access the same live broadcast video and have cached the video to a CDN node closer to the present user. At this point, the data can be obtained from the caching node faster. Thus, it can be seen that if the requested content is already cached in the nodes of the whole CDN network, the access time of a shortest returning-to-the-source path obtained by scheduling based on certain methods may be not the shortest, and an optimal service node is not provided for the user. Therefore, it is an urgent problem to be solved to provide a service node with shorter access time for the user and enhance user experience if the requested content is already cached in the nodes of the whole CDN network.

The present disclosure provides a scheduling method and server for a CDN service node, solving the problem that an optimal CDN node cannot be scheduled for the user, which affects user experience. According to the scheduling method and server for the CDN service node of the embodiments of the present disclosure, distances between all nodes are determined globally, such that when a scheduling center schedules the node for the user, the node closest to the user can be determined directly based on the minimum spanning tree, and reaction time of scheduling is reduced. Besides, the node that has cached a video requested by the user in all nodes is determined as the caching node, and the caching node closest to the user is determined according to the minimum spanning tree, such that decrease of a service quality because of delay of response time caused by direct returning to the source is avoided.

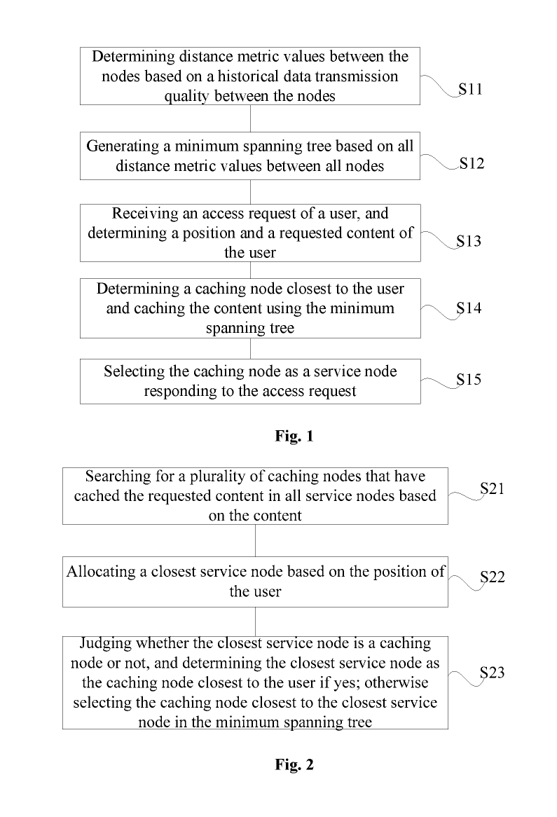

As shown in FIG. 1, a scheduling method for a CDN service node according to an embodiment of the present disclosure includes the following steps.

S11: a scheduling center determines distance metric values between the nodes based on a historical data transmission quality between the nodes;

S12: the scheduling center generates a minimum spanning tree based on all distance metric values between all nodes; the distance metric values between adjacent nodes are weights between the adjacent nodes, and the minimum spanning tree related to all nodes is obtained based on a specific algorithm; the specific algorithm may be an algorithm calculating the minimum spanning tree, for example, a Prim algorithm and a Kruskal algorithm; the two algorithms are listed here, but the algorithms are not limited to the two algorithms;

S13: the scheduling center receives an access request of a user, and determines a position and a requested content of the user; position information is the information of a region where the user is in, and the requested content is the feature information of a video requested by the user, for example, the name of the video requested by the user;

S14: the scheduling center determines a caching node closest to the user and caching the content using the minimum spanning tree; the minimum spanning tree related to all nodes is obtained according to step S13, and then the node caching the content requested by the user is selected from the minimum spanning tree;

S15: the scheduling center selects the caching node as a service node responding to the access request.

In the present embodiment, the scheduling center determines the distances between all nodes globally, such that the node closest to the user can be determined directly based on the minimum spanning tree when the scheduling center schedules the node for the user, and reaction time of scheduling is reduced. In addition, the scheduling center determines the video nodes that have cached an access request of the user in all nodes to be the caching nodes, and then determines the caching node closest to the user based on the minimum spanning tree, such that the decrease of a service quality because of delay of response time caused by direct returning to the source is avoided. In the embodiments of the present disclosure, the minimum spanning tree can be generated by a pattern formed by all nodes based on a data transmission rate, round-trip time and a packet loss rate between all nodes.

In some embodiments, the scheduling center determines distance metric values between the nodes based on a historical data transmission quality between the nodes, and the historical data transmission quality includes at least one of a data transmission rate, round-trip time and a packet loss rate. In addition, the generating by the scheduling center a minimum spanning tree based on all distance metric values between all nodes includes the following steps.

The scheduling center endows a reciprocal of the data transmission rate, the round-trip time and the packet loss rate with a first weight, a second weight and a third weight respectively; the scheduling center weight sums the reciprocal of the data transmission rate, the round-trip time and the packet loss rate to obtain the distance metric values between the nodes; and the scheduling center generates the minimum spanning tree based on the distance metric values between the nodes. The scheduling center can correspondingly adjust the first weight, second weight and third weight, of which the sum is 1, based on the influence degrees of the reciprocal of the data transmission rate, the round-trip time and the packet loss rate on the calculating of the distances between the nodes. That is, the three weights are normalized, such that the weights can be adjusted in real time based on the influence degrees of the three factors (the reciprocal of the data transmission rate, the round-trip time and the packet loss rate) on the calculated distances. Proportions of the reciprocal of the data transmission rate, the round-trip time and the packet loss rate can be adjusted more reasonably, so as to obtain the distance metric values between the nodes as accurate as possible. Therefore, the distances between all nodes can be determined more accurately.

In the present embodiment, the scheduling center measures the distance between two nodes by comprehensively considering a downloading rate, round-trip time and a packet loss rate between two nodes (the downloading rate is a measurement on the speed of data transmission between the two nodes; the larger the downloading speed is, the smaller the distance between the two nodes is, so that the downloading rate is in inverse proportion to the distance between the two nodes; the round-trip time is the time that one complete communication is finished between the two nodes, and the shorter the round-trip time is, the smaller the distance between the two nodes is; the packet loss rate is a measurement on the completeness of transmitted information between the two nodes in communication, and the larger the packet loss rate is, the less complete the transmitted information between the two nodes is, namely, the larger the distance between the two nodes is). As a result, a finally determined distance value between the two nodes is more reliable. Therefore, a more reliable scheduling basis is provided for content delivery of a CDN system, service quality for the user is ensured and user experience is enhanced consequently.

The data transmission rate and the round-trip time in the present embodiment can be directly monitored. Simply speaking, the round-trip time is the time from the moment that a sending party sends data to the moment that confirmation information from a receiving party is received. The round-trip time is an important performance index in computer networks, and means the total duration from the moment that the sending party sends the data to the moment that confirmation from the receiving party is received (the receiving party immediately sends the confirmation after receiving the data). A value of the round-trip time (RTT) is decided by three portions: link transmission time, processing time of a terminal system and queue time and processing time in the cache of a router. The packet loss rate (or Loss Tolerance) is a rate of the quantity of lost data packets to sent data groups in test and its calculating method is: “[(input messages-output messages)/input messages]*100%”. In the present embodiment, the packet loss rate is calculated by subtracting the data received by a second node from the data sent by a first node, then dividing the data sent by the first node by the difference of the subtraction, and multiplying the division result with 100%.

As shown in FIG. 2, in some embodiments, determining by the scheduling center a caching node closest to the user and caching the content using the minimum spanning tree includes the following steps.

S21: the scheduling center searches for a plurality of caching nodes that have cached the requested content in all service nodes based on the content;

S22: the scheduling center allocates a corresponding closest service node based on the position of the user; and

S23: the scheduling center judges whether the closest service node is a caching node or not, and determines the closest service node as the caching node closest to the user if yes; otherwise, the scheduling center selects the caching node closest to the closest service node in the minimum spanning tree. The judging whether the closest service node is a caching node or not specifically includes: judging whether the closest service node has cached the requested content, the requested content corresponding to the content of the access request of the user.

In the present embodiment, the scheduling center inquires multiple nodes that have cached a requested video in all nodes based on the content (a video content requested by the user) to serve as the caching nodes; that is, all caching nodes in the minimum spanning tree are determined at one step so that the closest caching node providing services for the user can be subsequently determined from the determined caching nodes. Therefore, the following situation is avoided: delay of the services provided for the user is caused by direct returning to the source when the service node closest to the user does not cache the requested video, and the user experience is affected.

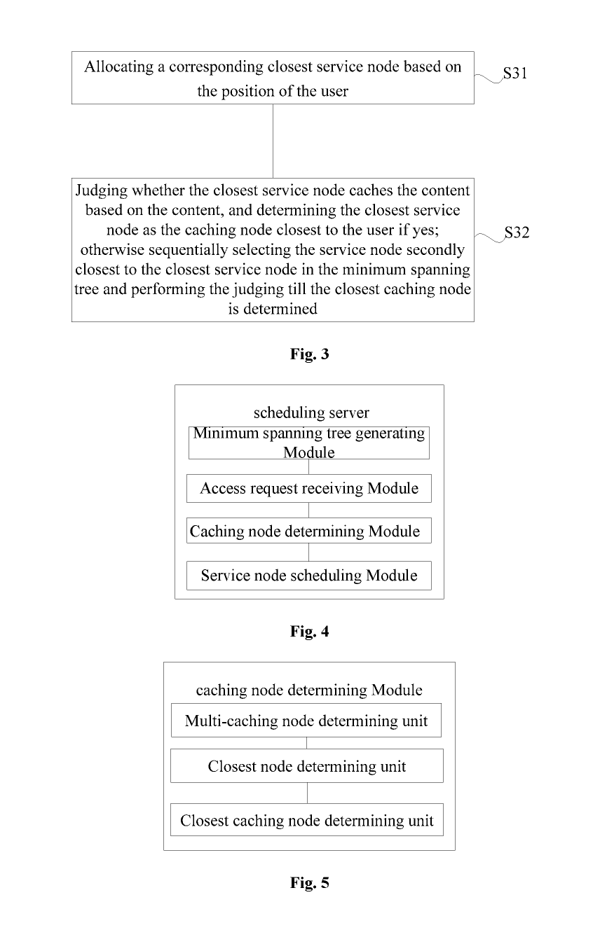

As shown in FIG. 3, in some embodiments, the determining a caching node closest to the user and caching the content using the minimum spanning tree includes the following steps.

S31: the scheduling center allocates a corresponding closest caching node based on the position of the user; and

S32: the scheduling center judges whether the closest service node caches the content based on the content, and determines the closest service node as the caching node closest to the user if yes; otherwise, the scheduling center sequentially selects the service node secondly closest to the closest service node in the minimum spanning tree (since the distances between all nodes in the minimum spanning tree have been determined, the service nodes are sequentially selected from near to far till the caching node is determined) and performs the judging till the closest caching node is determined.

The embodiments of the present disclosure further provide a method that the scheduling center determines a caching node from a minimum spanning tree as the closest caching node providing services for the user. Using this method, the following situation is avoided: delay of the service provided for the user is caused by direct returning to the source when the service node closest to the user does not cache the requested video, and the user experience is affected. The present embodiment differs from the previous embodiment in that the scheduling center selects the service node closest to the user in the minimum spanning tree one by one instead of directly determining all the caching nodes caching the requested video, and then judges whether the nodes are the caching nodes. If not, the service nodes secondly closest to the user are determined, and whether the service nodes are the caching node is judged. Thus, the service nodes closest to the user are selected from near to far in sequence according to the above steps and judging is performed till the caching nodes are determined. Such judging method avoids the redundancy waste on calculation caused by the fact that all caching nodes are determined at one step. The reason is that if n caching nodes are determined, but finally, only one optimal caching node exists, then the calculation on other n-1 nodes is redundant, causes waste, and generates certain time delay. On the contrary, in the present embodiment, by a one-by-one selecting and one-by-one judging manner, after the caching nodes are determined, the redundant calculation on other caching nodes is not needed. Therefore, the present embodiment of the disclosure saves the calculation time, shortens the time of scheduling the caching nodes and providing service for the user, and enhances user experience.

Hardware processor can be used to implement relevant function module of embodiments of the present disclosure.

It should be noted that the foregoing embodiments of method are described as a combination of a series of actions for the sake of brief description. The skilled of the art could understand that the application is not restricted by the order of actions as described, because some steps may be carried out in other order or simultaneously in the present application. Further, it should also be understood by the skilled in the art that the embodiments described in the description are preferable, and hence some actions or modules involved therein are not essential to the present application.

In the above embodiments, different emphasis is placed on respective embodiments, and hence for those portions without a detailed description in an embodiment, reference can be made to relevant portions in other embodiments.

As shown in FIG. 4, the embodiments of the present disclosure further provides a scheduling server for a CDN service node, which includes:

a minimum spanning tree determining module, configured to generate a minimum spanning tree based on all distance metric values between all nodes;

an access request receiving module, configured to receive an access request of a user, and determine a position and a requested content of the user;

a caching node determining module, configured to determine a caching node closest to the user and caching the content using the minimum spanning tree; and

a service node scheduling module, configured to select the caching node as a service node responding to the access request.

In the present embodiment, the scheduling server determines the distances between all nodes globally, such that when the scheduling center (the scheduling sever is the scheduling center, or the scheduling server is one or more servers of the scheduling center) schedules the nodes for the user, the node closest to the user can be generated directly based on the minimum spanning tree, and reaction time of scheduling is reduced. In addition, the scheduling server determines the video nodes that have cached the access request of the user in all nodes as the caching nodes, and then the caching node closest to the user is determined based on the minimum spanning tree. The technical problem of decrease of a service quality because of delay of response time caused by direct returning to the source is avoided.

In the present embodiment, the scheduling server of the CDN service nodes may be single servers or server clusters, all the modules may be single servers or server clusters, at this point, the interaction between all the modules is represented as the interaction between the servers or server clusters corresponding to the modules, and the servers or server clusters corresponding to all the modules constitute the scheduling server of the present disclosure together.

Specifically, the scheduling server consisting of the servers or server clusters corresponding to all the modules includes:

a minimum spanning tree determining server or server cluster, configured to generate a minimum spanning tree based on all distance metric values between all nodes;

an access request receiving server or server cluster, configured to receive an access request of a user, and determine a position and a requested content of the user;

a caching node determining server or server cluster, configured to determine a caching node closest to the user and caching the content using the minimum spanning tree; and

a service node scheduling server or server cluster, configured to select the caching node as a service node responding to the access request.

In an alternative embodiment, several modules in the modules may constitute one server or server cluster together. For example, the minimum spanning tree determining module constitutes a first server or first server cluster, the access request receiving module constitutes a second server or second server cluster, and the caching node determining module and the service node scheduling module constitute a third server or third server cluster.

At this point, interaction between the modules is represented as the interaction between the first to third servers or between the first to third server clusters, and the first to third servers or between the first to third server clusters constitute the scheduling sever of the present disclosure together.

In the embodiments of the present disclosure, the scheduling server may further include: a distance metric value module, configured to determine distance metric values between the nodes based on a historical data transmission quality between the nodes.

In the present embodiment, the distance metric value module is a single server or server cluster, and constitutes the scheduling server together with the single servers or server clusters corresponding to the minimum spanning tree determining module, the access request receiving module, the caching node determining module and the service node scheduling module respectively. At this point, the interaction between all the modules constituting the scheduling server is represented as the interaction between the single servers or server clusters corresponding to all the modules.

Specifically, the scheduling server consisting of the servers or server clusters corresponding to all the modules includes:

a distance metric value sever or server cluster, configured to determine distance metric values between the nodes based on a historical data transmission quality between the nodes;

a minimum spanning tree determining server or server cluster, configured to generate a minimum spanning tree based on all distance metric values between all nodes;

an access request receiving server or server cluster, configured to receive an access request of a user, and determine a position and a requested content of the user;

a caching node determining server or server cluster, configured to determine a caching node closest to the user and caching the content using the minimum spanning tree; and

a service node scheduling server or server cluster, configured to select the caching node as a service node responding to the access request.

In an alternative embodiment, several modules in the modules may constitute one server or server cluster together. For example, the minimum spanning tree determining module and the distance metric value module constitute a first server or first server cluster, the access request receiving module constitutes a second server or second server cluster, and the caching node determining module and the service node scheduling module constitute a third server or third server cluster.

At this point, interaction between the modules is represented as the interaction between the first to third servers or between the first to third server clusters, and the first to third servers or between the first to third server clusters constitute the scheduling sever of the present disclosure together.

In the embodiments of the present disclosure, the minimum spanning tree may be generated by a pattern consisting of all nodes based on a historical data transmission quality, round-trip time and a packet loss rate between all nodes.

In some embodiments, the distance metric values between the nodes are determined based on the historical data transmission quality, which includes at least one of a data transmission rate, round-trip time and a packet loss rate, between the nodes. In the present embodiment, the distance between two nodes is calculated by comprehensively considering a downloading rate, round-trip time and a packet loss rate between the two nodes (the downloading rate is a measure on the speed of data transmission between the two nodes, the larger the downloading speed is, the smaller the distance between the two nodes is, so that the downloading rate is in inverse proportion to the distance between the two nodes; the round-trip time is the time that once complete communication is finished between the two nodes, and the shorter the round-trip time is, the smaller the distance between the two nodes is; the packet loss rate is a measure on completeness of transmitted information between the two nodes in communication, and the larger the packet loss rate is, the less complete the transmitted information between the two nodes is, namely the larger the distance between the two nodes is). Such that the finally determined distance value between the two nodes is more reliable, therefore, a more reliable scheduling basis is provided for content delivery of a CDN system, service quality for the user is ensured and user experience is enhanced consequently.

As shown in FIG. 5, in some embodiments, the caching node determining module includes:

a multi-caching node determining unit, configured to search for a plurality of caching nodes that have cached the requested content in all service nodes based on the content;

a closest node determining unit, configured to allocate a closest service node based on the position of the user; and

a closest caching node determining unit, configured to judge whether the closest service node is a caching node or not, and determine the closest service node as the caching node closest to the user if yes; otherwise select the caching node closest to the closest service node in the minimum spanning tree.

In the present embodiment, the caching node determining module may be a single server or server cluster, and each unit may be a single server or server cluster. At this point, the interaction between the units is represented as the interaction between the single servers or server clusters corresponding to all the units, and the servers or server clusters constitute the caching node determining module together to form the scheduling server of the present disclosure.

In an alternative embodiment, several units in the plurality of units may constitute one server or server cluster.

In the present disclosure, the nodes that have cached a requested video in all the node are searched as the caching nodes based on the content (a video content requested by the user); that is, all caching nodes in the minimum spanning tree are determined at one step so that the closest caching node providing services for the user can be subsequently determined from the determined caching nodes. Therefore, the following situation is avoided: delay of the services provided for the user is caused by direct returning to the source when the service node closest to the user does not cache the requested video, and the user experience is affected.

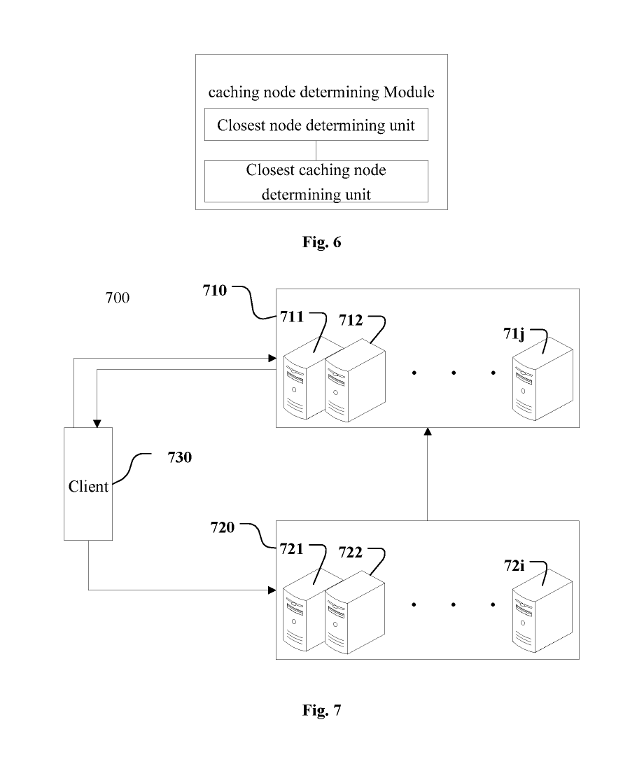

As shown in FIG. 6, in some embodiments, the caching node determining module includes:

a closest node determining unit, configured to allocate a corresponding closest service node based on the position of the user; and

a closest caching node determining unit, configured to judge whether the closest service node caches the content based on the content, and determine the closest service node as the caching node closest to the user if yes; otherwise sequentially select the service node secondly closest to the closest service node in the minimum spanning tree and perform the judging till the closest caching node is determined.

In the present embodiment, the caching node determining module may be one server or server cluster, wherein each unit may be a single server or server cluster. At this point, interaction between the units is represented as the interaction between the servers or server clusters corresponding to all the units, and the servers or server clusters constitute the caching node determining module to form the scheduling server of the present disclosure.

In an alternative embodiment, several units in the plurality of units may constitute one server or server cluster.

The embodiments of the present disclosure further provide a server that determines a caching node from a minimum spanning tree to be the closest caching node providing service for the user, and a situation that delay of the service provided for the user is caused by direct returning to the source when the service node closest to the user does not cache the requested video, and the user experience is affected is avoided. The present embodiment differs from the previous embodiment in that the closest caching node determining unit selects the service node closest to the user in the minimum spanning tree one by one instead of directly determining all the caching nodes caching the requested video, and then judges whether the nodes are the caching nodes. If not, the service nodes secondly closest to the user are determined, and whether the service nodes are the caching node is judged. Thus, the service nodes closest to the user are selected from near to far in sequence according to the above steps and judging is performed till the caching nodes are determined. Such judging method avoids the redundancy waste on calculation caused by the fact that all caching nodes are determined at one step. The reason is that if n caching nodes are determined, but finally, only one optimal caching node exists, then the calculation on other n-1 nodes is redundant and causes waste and certain time delay. On the contrary, in the present embodiment, by a one-by-one selecting and one-by-one judging manner, after the caching nodes are determined, the redundancy calculation on other caching nodes is not needed. Therefore, the present embodiment of the disclosure saves calculation time, shortens the time of scheduling the caching nodes and providing service for the user, and enhances user experience.

In the embodiments of the present disclosure, related function modules may be implemented by a hardware processor.

FIG. 7 shows a system structure 700 for implementing a scheduling method and scheduling server for a CDN service node of the present disclosure, the systems structure includes a scheduling center 710, a CDN node group 720 and a client 730, wherein the scheduling center 710 includes scheduling servers 711-71j and the CDN node group includes CDN nodes 721-72i. In the system structure, a user sends an access request (for example, a video access request) to the scheduling center by the client 730, the scheduling center parses the received access request to determine the position and requested content of the user, and determines the caching nodes closest to the user and caching the content using a minimum spanning tress generated based on information such as a reciprocal of a data transmission rate, round-trip time and a packet loss rate uploaded by the CDN node group 720. Finally, the caching node closest to the user and caching the content is determined, and the caching node is selected as the service node responding to the access request. The minimum spanning tree is generated based on all distance metric values between all nodes in the CDN node group 720. The caching node is selected as the service node responding to the access request.

The embodiments of the present disclosure further provide a computer-readable non-transitory storage medium, the storage medium stores one or more programs including an executable instruction, the executable instruction is read and executed by an electronic device (including but not limited to a computer, a server, or a network device, etc.) so as to execute the related steps in the above method embodiments. The steps include the followings, for example:

determining distance metric values between the nodes;

generating a minimum spanning tree based on all distance metric values between all nodes;

receiving an access request of a user, and determining a position and a requested content of the user;

determining a caching node closest to the user and caching the content using the minimum spanning tree; and

selecting the caching node as a service node responding to the access request.

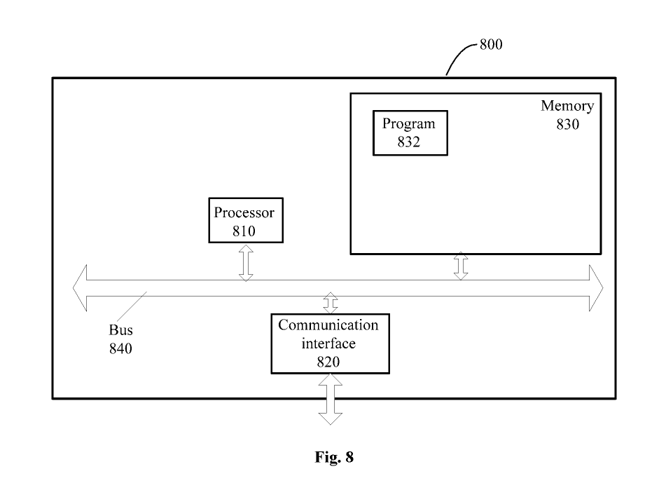

FIG. 8 shows a schematic structural drawing of an electronic device 800 (including but not limited to a computer, a server, or a network device, etc.) of the present disclosure, and the specific embodiments of the present disclosure do not limit specific implementation of the electronic device 800. As shown in FIG. 8, the electronic device 800 may include:

a processor 810, a communication interface 820, a memory 830 and a communication bus 840, wherein

the processor 801, the communication interface 820 and the memory 830 communicate with one another by the communication bus 840.

The communication interface 820 is used for communicating with a network element such as a client.

The processor 810 is configured to execute a program 832 in the memory 830 and specifically execute the related steps in the method embodiments.

Specifically, the program 832 may include a program code including a computer operation instruction.

The processor 810 may be a central processing unit (CPU), or an application specific integrated circuit (ASIC), or configured to be execute one or more integrated circuits executing the embodiments of the present application.

The scheduling server of the above embodiment includes:

a memory, configured to store the computer operation instruction;

a processor, configured to execute the computer operation instruction stored by the memory, to execute the operations of:

determining distance metric values between the nodes;

generating a minimum spanning tree based on all distance metric values between all nodes;

receiving an access request of a user, and determining a position and a requested content of the user;

determining a caching node closest to the user and caching the content using the minimum spanning tree; and

selecting the caching node as a service node responding to the access request.

According to an additional aspect of the present disclosure, a non-transitory computer-readable storage medium storing executable instructions may be provided. The executable instructions, when executed by a processor, may cause the processor to: determine distance metric values between the nodes, generate a minimum spanning tree based on all distance metric values between all nodes, receive an access request of a user, and determining a position and a requested content of the user, determine a caching node closest to the user and caching the content using the minimum spanning tree, and select the caching node as a service node responding to the access request.

The foregoing embodiments of device are merely illustrative, in which those units described as separate parts may or may not be separated physically. Displaying part may or may not be a physical unit, i.e., may locate in one place or distributed in several parts of a network. Some or all modules may be selected according to practical requirement to realize the purpose of the embodiments, and such embodiments can be understood and implemented by the skilled person in the art without inventive effort.

A person skilled in the art can clearly understand from the above description of embodiments that these embodiments can be implemented through software in conjunction with general-purpose hardware, or directly through hardware. Based on such understanding, the essence of foregoing technical solutions, or those features may be embodied as software product stored in computer-readable medium such as ROM/RAM, diskette, optical disc, etc., and including instructions for execution by a computer device (such as a personal computer, a server, or a network device) to implement methods described by foregoing embodiments or a part thereof.

It would be appreciated by the skilled in the art that, the embodiments of the present disclosure can be provided as method, system, or computer program product. Therefore, the present disclosure can be implemented in various ways, such as purely by hardware, or purely by software, or a combination of software and hardware. Moreover, the present disclosure can be implemented as a computer program product including one or more computer executable program codes which are stored on a computer readable memory medium (including but not limited to a disk storage or optic memory, etc.).

The present disclosure is described in reference to method, device (or system), and flow chart and/or block diagram of computer program product of embodiment of the disclosure. It should be understood that each flow and/or block and a combination thereof in a flow chart and/or block diagram can be implemented by computer program instruction. These computer program instruction can be provided to a universal computer, a dedicated computer, an embedded processor or a processor of other programmable data processing device to generate a machine, so that a device capable of realizing functions designated by one or more flows of a flow chart and/or one or more blocks of a block diagram can be generated through execution of instructions by a computer or processor of other programmable data processing device.

These computer program instructions may be stored in a computer readable memory which can guide the computer or other programmable data processing device to operate in a special way, so that the instruction stored in the computer readable memory generates a product including an instruction device which carries out functions designated by one or more flows of a flow chart and/or one or more blocks of a block diagram. These computer program instructions can also be loaded on a computer or other programmable data processing device so as to enable a series of operations to be carried out on the computer or other programmable device to realize processing of the computer, thus providing operations for achieving functions designated by one or more flows of a flow chart and/or one or more blocks of a block diagram by the instructions executed by the computer or other programmable device.

The present disclosure may include dedicated hardware implementations such as application specific integrated circuits, programmable logic arrays and other hardware devices. The hardware implementations can be constructed to implement one or more of the methods described herein. Applications that may include the apparatus and systems of various examples can broadly include a variety of electronic and computing systems. One or more examples described herein may implement functions using two or more specific interconnected hardware modules or devices with related control and data signals that can be communicated between and through the modules, or as portions of an application-specific integrated circuit. Accordingly, the computing system disclosed may encompass software, firmware, and hardware implementations. The terms “module,” “sub-module,” “unit,” or “sub-unit” may include memory (shared, dedicated, or group) that stores code or instructions that can be executed by one or more processors.

Finally, it should be noted that, the above embodiments are merely provided for describing the technical solutions of the present disclosure, but not intended as a limitation. Although the present disclosure has been described in detail with reference to the embodiments, those skilled in the art will appreciate that the technical solutions described in the foregoing various embodiments can still be modified, or some technical features therein can be equivalently replaced. Such modifications or replacements do not make the essence of corresponding technical solutions depart from the spirit and scope of technical solutions embodiments of the present disclosure.

What is claimed is:

1. A scheduling method for a Content Delivery Network (CDN) service node, comprising:
determining distance metric values between the nodes;
generating a minimum spanning tree based on all distance metric values between all nodes;
receiving an access request of a user, and determining a position and a requested content of the user;
determining a caching node closest to the user and caching the content using the minimum spanning tree; and
selecting the caching node as a service node responding to the access request.

2. The scheduling method for a CDN service node according to claim 1, wherein determining a caching node closest to the user and caching the content using the minimum spanning tree comprises:
searching for a plurality of caching nodes that have cached the requested content in all service nodes based on the content;
allocating a closest service node based on the position of the user; and
judging whether the closest service node is a caching node or not, and determining the closest service node as the caching node closest to the user if yes;
otherwise selecting the caching node closest to the closest service node in the minimum spanning tree.

3. The scheduling method for a CDN service node according to claim 1, wherein determining a caching node closest to the user and caching the content using the minimum spanning tree comprises:
allocating a corresponding closest service node based on the position of the user; and
judging whether the closest service node caches the content based on the content, and determining the closest service node as the caching node closest to the user if yes; otherwise sequentially selecting the service node secondly closest to the closest service node in the minimum spanning tree and performing the judging till the closest caching node is determined.

4. The scheduling method for a CDN service node according to claim 1, further comprising:
determining distance metric values between the nodes based on a historical data transmission quality between the nodes.

5. The scheduling method for a CDN service node according to claim 4, wherein a historical data transmission quality exists and at least comprises one of a data transmission rate, round-trip time and a packet loss rate.

6. A scheduling server for a CDN service node, comprising;
at least one processor; and
a memory communicably connected with the at least one processor for storing instructions executable by the at least one processor, wherein execution of the instructions by the at least one processor causes the at least one processor to:
generate a minimum spanning tree based on all distance metric values between all nodes;
receive an access request of a user, and determine a position and a requested content of the user;
determine a caching node closest to the user and caching the content using the minimum spanning tree; and
select the caching node as a service node responding to the access request.

7. The scheduling server for a CDN service node according to claim 6, wherein the instructions that cause the at least one processor to determine the caching node further cause the at least one processor to:
search for a plurality of caching nodes that have cached the requested content in all service nodes based on the content;
allocate a closest service node based on the position of the user; and
judge whether the closest service node is a caching node or not, and determine the closest service node as the caching node closest to the user if yes; otherwise select the caching node closest to the closest service node in the minimum spanning tree.

8. The scheduling server for a CDN service node according to claim 6, wherein the instructions that cause the at least one processor to determine the caching node further cause the at least one processor to:
allocate a corresponding closest service node based on the position of the user; and
judge whether the closest service node caches the content based on the content, and determine the closest service node as the caching node closest to the user if yes; otherwise sequentially select the service node secondly closest to the closest service node in the minimum spanning tree and perform the judging till the closest caching node is determined.

9. The scheduling server for a CDN service node according to claim 6, wherein the execution of the instructions further causes the at least one processor to:
determine distance metric values between the nodes based on a historical data transmission quality between the nodes.

10. The scheduling server for a CDN service node according to claim 9, wherein a historical data transmission quality exists and comprises at least one of a data transmission rate, round-trip time and a packet loss rate.

11. A non-transitory computer-readable storage medium storing executable instructions, wherein the executable instructions, when executed by a processor, cause the processor to:
determine distance metric values between the nodes;
generate a minimum spanning tree based on all distance metric values between all nodes;
receive an access request of a user, and determining a position and a requested content of the user;
determine a caching node closest to the user and caching the content using the minimum spanning tree; and
select the caching node as a service node responding to the access request.

12. The non-transitory computer-readable storage medium according to claim 11, wherein the executable instructions, when executed by the processor, cause the processor to determine a caching node closest to the user and caching the content using the minimum spanning tree, further cause the processor to:
search for a plurality of caching nodes that have cached the requested content in all service nodes based on the content;
allocate a closest service node based on the position of the user; and
judge whether the closest service node is a caching node or not, and determine the closest service node as the caching node closest to the user if yes; otherwise select the caching node closest to the closest service node in the minimum spanning tree.

13. The non-transitory computer-readable storage medium according to claim 11, wherein the executable instructions, when executed by the processor, cause the processor to determine a caching node closest to the user and caching the content using the minimum spanning tree, further cause the processor to:
allocate a corresponding closest service node based on the position of the user; and
judge whether the closest service node caches the content based on the content, and determine the closest service node as the caching node closest to the user if yes; otherwise sequentially select the service node secondly closest to the closest service node in the minimum spanning tree and judge till the closest caching node is determined.

14. The non-transitory computer-readable storage medium according to claim 11, wherein a historical data transmission quality exists and at least comprises one of a data transmission rate, round-trip time and a packet loss rate.

15. The non-transitory computer-readable storage medium according to claim 11, wherein the executable instructions, when executed by the processor, further cause the processor to:
determine distance metric values between the nodes based on a historical data transmission quality between the nodes.
